(19) United States
(12) Patent Application Publication
(10) Pub. No.: US 2004/0023085 A1
(43) Pub. Date: Feb. 5, 2004

(54) Prodoction of electricity from fuel cells depending on gasification of carbonatious compounds

(76) Inventor: Gene E. Lightner, Federal Way, WA (US)

Correspondence Address: Gene E. Lightner, 706 S.W. 296th St., Federal Way, WA, 98023, US

(21) Appl. No.: 10/212,366

(22) Filed: Aug. 5, 2002

(51) Int. Cl. H01M 8/06

(52) U.S. Cl. 429/17

(57) ABSTRACT

Gasification of carbonatious compounds from steam produces a gas containing hydrogen, carbon monoxide, and organic compounds subject to reforming. Resultant gas supplies fuel to a plurality of fuel cells for internal reforming and steam shifting of carbon monoxide to form hydrogen and carbon dioxide and generate electricity and create exothermic heat. High temperature fuel cells exothermic heat, in the form of steam from the fuel cell reaction, provide steam for gasification of carbonatious compounds contained in a vessel. Energy for gasification is derived from combustion of carbonatious compounds or electricity from a plurality of fuel cells wherein the vessel for gasification is maintained at a temperature of about 600 degrees Celsius to about 1,000 degrees Celsius. Carbonatious compounds regularly consist of coal or comparable carbonatious compounds, whereby gasification of carbonatious compounds provides fuel to power fuel cells to generate electricity.

### BACKGROUND OF THE INVENTION

Common methods for gasification of coal depend on air or oxygen for combustion of coal to achieve heat for gasification, taught within U.S. Pat. No. 5,089,031 and U.S. Pat. No. 3,971,639. Gasification depends on a fluidized bed to produce combustible gases subject to combustion to produce steam. Gasification products, containing hydrogen and carbon monoxide, steam and volatile organic compounds can then be subjected to reforming and steam shifting to create hydrogen and carbon dioxide. These procedures can be accomplished by internal reforming within high temperature fuel cells. Various descriptions of internal reforming, employing multiple fuel cells operating at high temperature are found, for example, within U.S. Pat. No. 6,344,289, U.S. Pat. No. 6,200,696 and U.S. Pat. No. 6,110,614, to accomplish reforming of hydrocarbon fuel to form hydrogen without utilizing a catalyst. Accordingly these fuel cells are absent of carbon monoxide poisoning. State of the art fuel cells operating at a temperature from about 600 degrees Celsius to about 1,000 degrees Celsius are designated as molten carbonate (MCFC) and solid oxide (SOFC) fuel cells. Hydrogen, thus created, reacts within the fuel cells to create direct current and water vapor.

Therefore, an object of this invention is to obviate many of the limitations and disadvantages of the prior art.

This invention relates to gasification of carbonatious compounds to supply gas to fuel cells.

An important object of this invention is to apply gasification of carbonatious compounds to reforming and steam splitting by MCFC or SOFC fuel cells.

A secondary object of this invention is to employ a plurality of MCFC or SOFC fuel cells to generate electricity from gasification of carbonatious compounds.

Furthermore, an object of this invention is to utilize internally generated exothermic heat which is transmitted, as steam, to carbonatious compounds for gasification.

An additional object of this invention is to maintain temperature of the vessel required for gasification of carbonatious compounds.

With the above and other objects in view, this invention relates to the novel features and alternatives and combinations presently described in the brief description of the invention.

### PHRASEOLOGY APPLIED IN THE INVENTION

Steam provided from exothermic heat generated by the reaction of hydrogen and oxygen within fuel cells is used for gasification of carbonatious compounds. State of the art gasification of carbonatious compounds employs a fixed bed or a fluidized bed to react steam with carbonatious compounds for production of gasification compounds containing hydrogen, carbon monoxide and organic compounds The resulting gasification compounds are subject to internal reforming and steam splitting by a plurality of MCFC or SOFC fuel cells to form a gas containing hydrogen and carbon dioxide. High temperature fuel cells react with hydrogen, within this gaseous mixture and oxygen from air, simultaneously reforming volatile organic compounds and accomplish steam shifting to create hydrogen. Reforming and steam splitting are functions actualized within fuel cells selected from the group consisting of molten carbonate fuel cells, solid oxide fuel cells or a combination thereof. Selected fuel cell type, upon reaction at high temperature, with hydrogen and oxygen from air, generates internal exothermic heat as steam. The vessel, essential for gasification, is provided steam, generated by fuel cell exothermic heat and is maintained at a temperature of about 600 degrees Celsius to about 1,000 degrees Celsius by heat generated by combustion of carbonatious compounds or by heat generated by electricity derived from fuel cells. Accordingly, heat is transmitted to the carbonatious compounds gasification vessel.

Direct current generated by fuel cells is converted to alternating current by an inverter, in electrical phase of a power grid. Resulting alternating current is converted by a transformer to a voltage suitable for a power grid.

The net result is generation of electricity suitable for a power grid, by fuel cells relying on gasification of carbonatious compounds.

### BRIEF DESCRIPTION OF THE INVENTION

The present invention, in its broadest aspect, is a method to generate electricity from a plurality of fuel cells supplied by gasification of carbonatious compounds, which comprises: providing fuel cells, carbonatious compounds, and steam. Exothermic heat, generated within the fuel cells, is transmitted to the vessel used for carbonatious compounds gasification. Upon creation of steam and combining the steam with carbonatious compounds for gasification, a gas containing hydrogen, carbon monoxide and organic compounds is formed, subject to internal reforming by the fuel cells. The gasification of carbonatious compounds is, upon subjecting air to the gas derived from carbonatious compounds, reacts within the fuel cells to generate electricity and create exothermic heat.

Key features of this invention are:

Carbonatious compounds for gasification are restrained within a vessel.

Carbonatious compounds, subjected to gasification, is used to supply fuel to fuel cells.

Exothermic heat is generated within fueled fuel cells.

Steam is conveyed to the gasification vessel for gasification of carbonatious compounds

Carbonatious compounds are occasionally derived from tar sands.

Gasification of carbonatious compounds is with steam generated by fuel cells.

Fuel cells powered by gasification from carbonatious compounds will generate electricity.

Steam, generated by fuel cells, becomes superheated steam.

Fuel cells generate direct current generally converted to alternating current.

Heat required to maintain operating temperature for gasification is provided by combustion of carbonatious compounds or electricity from fuel cells and attains operating temperature.

The vessel for gasification contains a catalyst.

The method is practiced in a continuous fashion.

The method is operated at a pressure range of about one to ten atmospheres.

The vessel for gasification is a fluidized bed or a fixed bed.

Direct current, generated from fuel cells, is occasionally stored within a storage battery for subsequent withdrawal.

### BRIEF DESCRIPTION OF THE DRAWINGS

The features that are considered characteristic of this invention are set forth in the appended claims. This invention, however, both as to its origination and method of operations as well as additional advantages will best be understood from the following description when read in conjunction with the accompanying drawings in which:

FIG. 1 is a flow sheet denoting the invention as set forth in the appended claims.

FIG. 2 is a flow sheet denoting heat from combustion of carbonatious compounds for gasification of carbonatious compounds.

FIG. 3 is a flow sheet denoting electrical heat for gasification.

FIG. 4 is a flow sheet denoting direct current, obtained from a plurality of fuel cells, transferred to a DC/AC inverted to create alternating current

### DETAILED DESCRIPTION OF THE PREFERRED EMBODIMENT

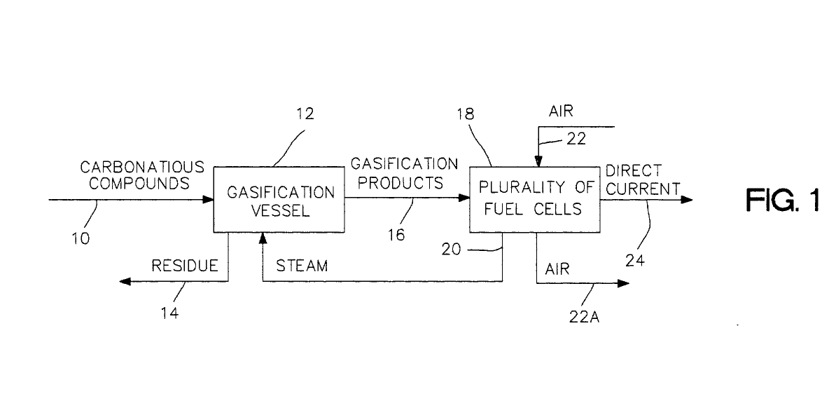

In the preferred embodiments of the present invention, gases, from a gasification vessel of carbonatious compounds is forwarded to fuel cells to generate electricity. Fuel cells and the gasification vessel are operated at an established temperature from about 600 degrees Celsius to about 1,000 degrees Celsius. The flow diagram of FIG. 1 illustrates the general preferred embodiments of the present invention. In the diagram, rectangles represent stages or functions of the present invention and not necessarily separate components. Arrows indicate direction of flow in the method.

Referring to FIG. 1, carbonatious compounds 10 are conveyed to gasification vessel 12 to create gasification products 16 and residue 14 for disposal. Gasification products 16 supplied to a plurality of fuel cells 18 which generates direct current 24 and creates exothermic heat as steam 20. Steam 20 is conducted to gasification vessel 12. Air 22, is provided to furnish oxygen to a plurality of fuel cells 18, and creates oxygen depleted air 22A from consumed oxygen. Gasification products 16 supplied to a plurality of fuel cells 18 contains organic compounds subject to internal reformation within a plurality of fuel cells 18, as well as steam shifting carbon monoxide to form hydrogen and carbon dioxide. Carbonatious compounds are regularly selected from the group consisting of coal, coke, bituminous coal and peat or a combination thereof. Fuel cells are regularly selected from the group consisting of molten carbonate fuel cells, solid oxide fuel cells or a combination thereof. Residue 14 for disposal, habitually consists of ash and slag derived from gasification of carbonatious compounds.

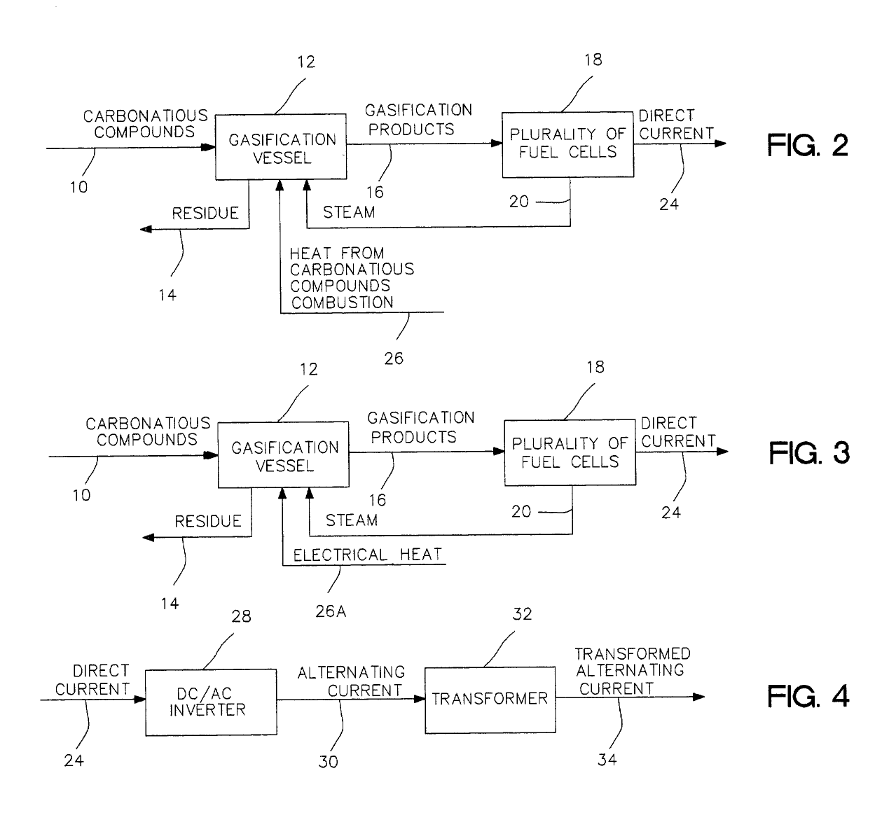

Referring to FIG. 2, carbonatious compounds 10 are conveyed to gasification vessel 12 to create gasification products 16 and residue 14 for disposal. Gasification products 16 supplied to a plurality of fuel cells 18 which generates direct current 24 and creates exothermic heat as steam 20. Steam 20 is conducted to gasification vessel 12. Heat from combustion of carbonatious compounds 26 is provided to gasification vessel 12 wherein the vessel is maintained at a temperature of about 600 degrees Celsius to about 1,000 degrees Celsius. Air for reaction within a plurality of fuel cells 18, and air for combustion of carbonatious compounds 26 is to be assumed and is unessential within FIG. 2.

Referring to FIG. 3, carbonatious compounds 10 are conveyed to gasification vessel 12 to create gasification products 16 and residue 14 for disposal. Gasification products 16 supplied to a plurality of fuel cells 18 which generates direct current 24 and creates exothermic heat as steam 20. Steam 20 is conducted to gasification vessel 12. Electrical heat 26A, as required, is added to the gasification vessel 12 is provided to gasification vessel 12 wherein the vessel is maintained at a temperature of about 600 degrees Celsius to about 1,000 degrees Celsius. Air for reaction within a plurality of fuel cells 18, is to be assumed and unimportant within FIG. 3.

Referring to FIG. 4, direct current 24 from a plurality of fuel cells 18 is inverted from direct current to alternating current by DC/AC inverter 28 to create alternating current 30 to be transferred to transformer 32 to provide transformed alternating current 34. Transformed alternating current 34, in electrical phase with a power grid, is admitted to the power grid.

What is claimed is:

1. A method to produce electricity from fuel cells depending on gasification of carbonatious compounds for fuel, which comprises:
providing a vessel for gasification, and
providing carbonatious compounds, and
providing a plurality of fuel cells, and
providing steam derived from said fuel cells, and
combining said steam with said carbonatious compounds for said gasification of the carbonatious compounds to form a gaseous mixture containing organic compounds, hydrogen and carbon monoxide, and
subjecting said gaseous mixture to said fuel cells, and
subjecting said gaseous mixture, containing organic compounds, to reforming by said fuel cells, and
subjecting carbon monoxide containing water vapor, within said gaseous mixture, to steam shifting by said fuel cells, and
subjecting air to said fuel cells for creation of steam and generate said electricity whereby gasification of carbonatious compounds provides energy to fuel cells for creation of steam for gasification of carbonatious compounds and generation of electricity.

2. The method as described in claim 1 wherein said fuel cells are selected from the group consisting of molten carbonate fuel cells, solid oxide fuel cells or a combination thereof.

3. The method as described in claim 1 wherein said carbonatious compounds are selected from the group consisting of coal, coke, bituminous coal and peat or a combination thereof.

4. The method as described in claim 1 wherein said carbonatious compounds are derived from tar sands.

5. The method of claim 1 wherein a plurality of said fuel cells are maintained at a temperature of about 600 degrees Celsius to about 1,000 degrees Celsius.

6. The method of claim 1 wherein said carbonatious compounds are restrained within said vessel preceding gasification.

7. The method of claim 6 wherein the vessel is maintained at a temperature of about 600 degrees Celsius to about 1,000 degrees Celsius.

8. The method of claim 6 wherein the vessel is maintained at a temperature of about 600 degrees Celsius to about 1,000 degrees Celsius by heat generated by electricity derived from fuel cells.

9. The method of claim 6 wherein the vessel is maintained at a temperature of about 600 degrees Celsius to about 1,000 degrees Celsius by heat generated by combustion of said carbonatious compounds.

10. The method of claim 1 wherein a plurality of said fuel cells generate direct current.

11. The method of claim 10 wherein the direct current is converted to alternating current in electrical phase within a power grid.

12. The method of claim 1 wherein a plurality of said fuel cells are operated at a temperature from about 600 degrees Celsius to about 1,000 degrees Celsius.

13. The method of claim 1 wherein a plurality of said fuel cells exothermic heat substantially forms said steam.

14. The method of claim 1 wherein said steam is superheated steam.

15. The method of claim 1 wherein said vessel contains a catalyst.

16. The method of claim 1 wherein said method is practiced in a continuous fashion.

17. The method of claim 1 wherein said method is operated at a pressure range of about one to ten atmospheres.

18. The method of claim 1 wherein said vessel is a fluidized bed.

19. The method of claim 1 wherein said vessel is a fixed bed.

20. The method of claim 1 wherein said method attains operating temperature from carbonatious compounds.
